(19) United States
(12) Patent Application Publication
(10) Pub. No.: US 2016/0277325 A1
(43) Pub. Date: Sep. 22, 2016

(54) SYSTEM AND METHOD FOR DISCOVERY AND EARLY NOTIFICATION OF FUTURE UNAVAILABILITY

(71) Applicant: International Business Machines Corporation, Armonk, NY (US)

(72) Inventors: RAM KRISHNAMURTHY, Westford, MA (US); Anurag Srivastava, Pune (IN)

(21) Appl. No.: 14/661,857

(22) Filed: Mar. 18, 2015

(51) Int. Cl. H04L 12/58

(52) U.S. Cl. CPC H04L 51/02; H04L 51/16; H04L 51/32

(57) ABSTRACT

A method, computer program product, and computer system for determining, by a computing device, one or more communication threads between a plurality of users. A first user of the plurality of users is identified as likely to be unavailable for a predetermined amount of time at a future date. An active communication thread of the one or more communication threads is identified. At least a portion of users of the plurality of users in the active communication thread is identified. A notification is sent to at least the portion of users in the active communication thread that the first user is likely to be unavailable for the predetermined amount of time at the future date based upon, at least in part, identifying that the first user of the plurality of users is likely to be unavailable for the predetermined amount of time at the future date and identifying the active communication thread, wherein the notification is sent prior to the future date.

### BACKGROUND

Some email client applications may be equipped with a notification function that a user may enable to let other users know that the user is “Out of the Office”. For example, at time T₀, the user may set up an “Out of Office” function that is to be enabled between, e.g., a beginning date T₁ and end date T₂. In the example, if an email is sent by, e.g., a second user and received by the email client application before T₁ (e.g., before the dates when the “Out of Office” function is enabled), no automated “Out of Office” notification message is generally sent back to the second user. Continuing with the example, if the email is sent by the second user and received by the email client application between T₁ and T₂ (e.g., while the “Out of Office” function is enabled), an automated “Out of Office” notification message may be sent back to the second user.

### BRIEF SUMMARY OF DISCLOSURE

In one example implementation, a method, performed by one or more computing devices, may include but is not limited to determining, by a computing device, one or more communication threads between a plurality of users. A first user of the plurality of users may be identified as likely to be unavailable for a predetermined amount of time at a future date. An active communication thread of the one or more communication threads may be identified. At least a portion of users of the plurality of users in the active communication thread may be identified. A notification may be sent to at least the portion of users in the active communication thread that the first user is likely to be unavailable for the predetermined amount of time at the future date based upon, at least in part, identifying that the first user of the plurality of users is likely to be unavailable for the predetermined amount of time at the future date and identifying the active communication thread, wherein the notification may be sent prior to the future date.

One or more of the following example features may be included. Identifying the active communication thread may include analyzing at least a portion of the one or more communication threads. Analyzing at least the portion of the one or more communication threads may include performing text analysis on at least the portion of the one or more communication threads. Performing text analysis may include determining at least one of content of the one or more communication threads, frequency of the one or more communication threads, and recentness of the one or more communication threads. Identifying the active communication thread may include applying a weight to at least one of the content of the one or more communication threads, the frequency of the one or more communication threads, and the recentness of the one or more communication threads. The one or more communication threads may include at least one of an email exchange with the first user, an instant message exchange with the first user, and a social media exchange with the first user. Approval from the first user may be received prior to sending the notification to at least the portion of users in the active communication thread that the first user is likely to be unavailable for the predetermined amount of time at the future date.

In another example implementation, a computing system includes a processor and a memory configured to perform operations that may include but are not limited to determining one or more communication threads between a plurality of users. A first user of the plurality of users may be identified as likely to be unavailable for a predetermined amount of time at a future date. An active communication thread of the one or more communication threads may be identified. At least a portion of users of the plurality of users in the active communication thread may be identified. A notification may be sent to at least the portion of users in the active communication thread that the first user is likely to be unavailable for the predetermined amount of time at the future date based upon, at least in part, identifying that the first user of the plurality of users is likely to be unavailable for the predetermined amount of time at the future date and identifying the active communication thread, wherein the notification may be sent prior to the future date.

One or more of the following example features may be included. Identifying the active communication thread may include analyzing at least a portion of the one or more communication threads. Analyzing at least the portion of the one or more communication threads may include performing text analysis on at least the portion of the one or more communication threads. Performing text analysis may include determining at least one of content of the one or more communication threads, frequency of the one or more communication threads, and recentness of the one or more communication threads. Identifying the active communication thread may include applying a weight to at least one of the content of the one or more communication threads, the frequency of the one or more communication threads, and the recentness of the one or more communication threads. The one or more communication threads may include at least one of an email exchange with the first user, an instant message exchange with the first user, and a social media exchange with the first user. Approval from the first user may be received prior to sending the notification to at least the portion of users in the active communication thread that the first user is likely to be unavailable for the predetermined amount of time at the future date.

In another example implementation, a computer program product resides on a computer readable storage medium that has a plurality of instructions stored on it. When executed by a processor, the instructions cause the processor to perform operations that may include but are not limited to determining one or more communication threads between a plurality of users. A first user of the plurality of users may be identified as likely to be unavailable for a predetermined amount of time at a future date. An active communication thread of the one or more communication threads may be identified. At least a portion of users of the plurality of users in the active communication thread may be identified. A notification may be sent to at least the portion of users in the active communication thread that the first user is likely to be unavailable for the predetermined amount of time at the future date based upon, at least in part, identifying that the first user of the plurality of users is likely to be unavailable for the predetermined amount of time at the future date and identifying the active communication thread, wherein the notification may be sent prior to the future date.

One or more of the following example features may be included. Identifying the active communication thread may include analyzing at least a portion of the one or more communication threads. Analyzing at least the portion of the one or more communication threads may include performing text analysis on at least the portion of the one or more communication threads. Performing text analysis may include determining at least one of content of the one or more communication threads, frequency of the one or more communication threads, and recentness of the one or more communication threads. Identifying the active communication thread may include applying a weight to at least one of the content of the one or more communication threads, the frequency of the one or more communication threads, and the recentness of the one or more communication threads. The one or more communication threads may include at least one of an email exchange with the first user, an instant message exchange with the first user, and a social media exchange with the first user. Approval from the first user may be received prior to sending the notification to at least the portion of users in the active communication thread that the first user is likely to be unavailable for the predetermined amount of time at the future date.

The details of one or more example implementations are set forth in the accompanying drawings and the description below. Other features and advantages will become apparent from the description, the drawings, and the claims.

### BRIEF DESCRIPTION OF THE DRAWINGS

FIG. 1 is an example diagrammatic view of a notification process coupled to a distributed computing network according to one or more example implementations of the disclosure;

FIG. 2 is an example diagrammatic view of a client electronic device of FIG. 1 according to one or more example implementations of the disclosure;

FIG. 3 is an example flowchart of the notification process of FIG. 1 according to one or more example implementations of the disclosure;

FIG. 4 is an example diagrammatic view of the notification process of FIG. 1 coupled to a distributed computing network according to one or more example implementations of the disclosure; and

FIG. 5 is an example diagrammatic view of a timeline that may be used with the notification process of FIG. 1 according to one or more example implementations of the disclosure.

Like reference symbols in the various drawings indicate like elements.

### DETAILED DESCRIPTION

### System Overview:

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

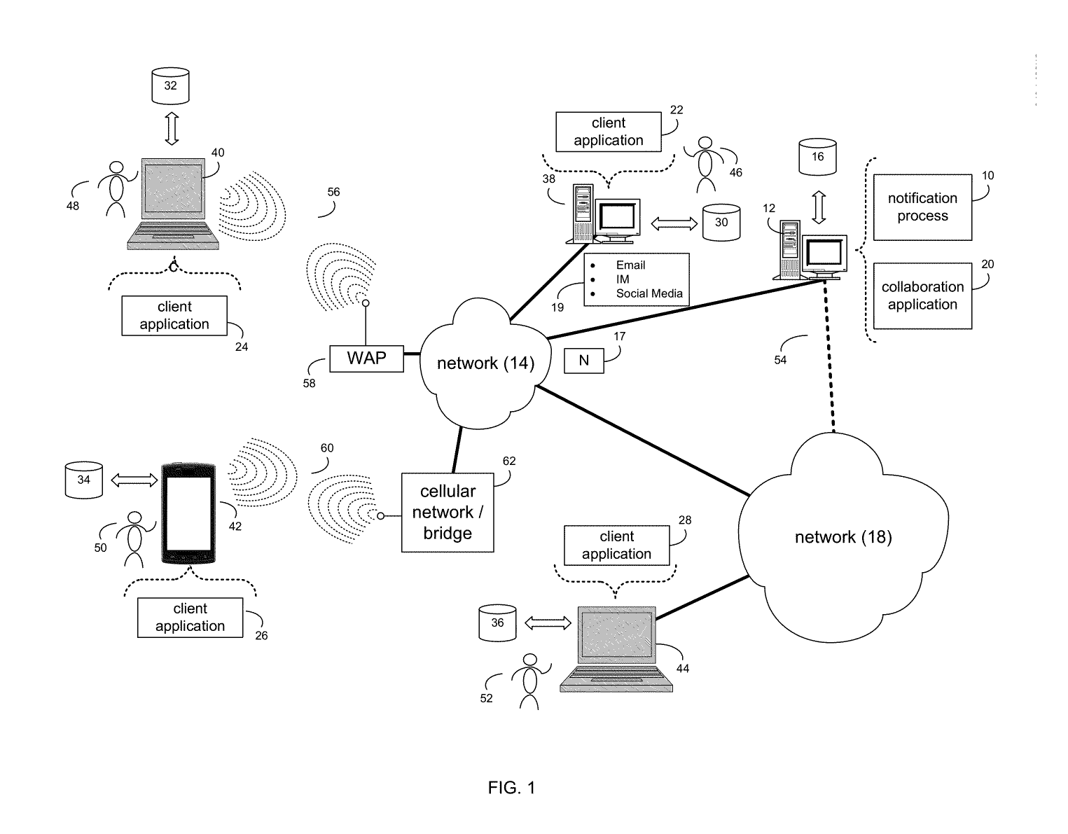

Referring now to FIG. 1, there is shown notification process 10 that may reside on and may be executed by a computer (e.g., computer 12), which may be connected to a network (e.g., network 14) (e.g., the internet or a local area network). Examples of computer 12 (and/or one or more of the client electronic devices noted below) may include, but are not limited to, a personal computer(s), a laptop computer(s), mobile computing device(s), a server computer, a series of server computers, a mainframe computer(s), or a computing cloud(s). Computer 12 may execute an operating system, for example, but not limited to, Microsoft® Windows®; Mac® OS X®; Red Hat® Linux®, or a custom operating system. (Microsoft and Windows are registered trademarks of Microsoft Corporation in the United States, other countries or both; Mac and OS X are registered trademarks of Apple Inc. in the United States, other countries or both; Red Hat is a registered trademark of Red Hat Corporation in the United States, other countries or both; and Linux is a registered trademark of Linus Torvalds in the United States, other countries or both).

As will be discussed below in greater detail, notification process 10 may determine, by a computing device, one or more communication threads between a plurality of users. A first user of the plurality of users may be identified as likely to be unavailable for a predetermined amount of time at a future date. An active communication thread (e.g., active communication thread 19) of the one or more communication threads may be identified. At least a portion of users of the plurality of users in the active communication thread may be identified. A notification (e.g., notification 17) may be sent to at least the portion of users in the active communication thread that the first user is likely to be unavailable for the predetermined amount of time at the future date based upon, at least in part, identifying that the first user of the plurality of users is likely to be unavailable for the predetermined amount of time at the future date and identifying the active communication thread, wherein the notification may be sent prior to the future date.

The instruction sets and subroutines of notification process 10, which may be stored on storage device 16 coupled to computer 12, may be executed by one or more processors (not shown) and one or more memory architectures (not shown) included within computer 12. Storage device 16 may include but is not limited to: a hard disk drive; a flash drive, a tape drive; an optical drive; a RAID array; a random access memory (RAM); and a read-only memory (ROM).

Network 14 may be connected to one or more secondary networks (e.g., network 18), examples of which may include but are not limited to: a local area network; a wide area network; or an intranet, for example.

Computer 12 may include a data store, such as a database (e.g., relational database, object-oriented database, triplestore database, etc.) and may be located within any suitable memory location, such as storage device 16 coupled to computer 12. Any data described throughout the present disclosure may be stored in the data store. In some implementations, computer 12 may utilize a database management system such as, but not limited to, “My Structured Query Language” (MySQL®) in order to provide multi-user access to one or more databases, such as the above noted relational database. The data store may also be a custom database, such as, for example, a flat file database or an XML database. Any other form(s) of a data storage structure and/or organization may also be used. Notification process 10 may be a component of the data store, a stand alone application that interfaces with the above noted data store and/or an applet/application that is accessed via client applications 22, 24, 26, 28. The above noted data store may be, in whole or in part, distributed in a cloud computing topology. In this way, computer 12 and storage device 16 may refer to multiple devices, which may also be distributed throughout the network.

Computer 12 may execute a collaboration application (e.g., collaboration application 20), examples of which may include, but are not limited to, e.g., a web conferencing application, a video conferencing application, a voice-over-IP application, a video-over-IP application, an Instant Messaging (IM)/“chat” application, a social media application, an email client application, a calendar client application, an SMS text application, or other application that allows for virtual meeting and/or remote collaboration. Notification process 10 and/or collaboration application 20 may be accessed via client applications 22, 24, 26, 28. Notification process 10 may be a stand alone application, or may be an applet/application/script/extension that may interact with and/or be executed within collaboration application 20, a component of collaboration application 20, and/or one or more of client applications 22, 24, 26, 28. Collaboration application 20 may be a stand alone application, or may be an applet/application/script/extension that may interact with and/or be executed within notification process 10, a component of notification process 10, and/or one or more of client applications 22, 24, 26, 28. One or more of client applications 22, 24, 26, 28 may be a stand alone application, or may be an applet/application/script/extension that may interact with and/or be executed within and/or be a component of notification process 10 and/or collaboration application 20. Examples of client applications 22, 24, 26, 28 may include, but are not limited to, e.g., a web conferencing application, a video conferencing application, a voice-over-IP application, a video-over-IP application, an Instant Messaging (IM)/“chat” application, a social media application, an email client application, a calendar client application, an SMS text application, or other application that allows for virtual meeting and/or remote collaboration, a standard and/or mobile web browser, a textual and/or a graphical user interface, a customized web browser, a plugin, an Application Programming Interface (API), or a custom application. The instruction sets and subroutines of client applications 22, 24, 26, 28, which may be stored on storage devices 30, 32, 34, 36, coupled to client electronic devices 38, 40, 42, 44, may be executed by one or more processors (not shown) and one or more memory architectures (not shown) incorporated into client electronic devices 38, 40, 42, 44.

Storage devices 30, 32, 34, 36, may include but are not limited to: hard disk drives; flash drives, tape drives; optical drives; RAID arrays; random access memories (RAM); and read-only memories (ROM). Examples of client electronic devices 38, 40, 42, 44 (and/or computer 12) may include, but are not limited to, a personal computer (e.g., client electronic device 38), a laptop computer (e.g., client electronic device 40), a smart/data-enabled, cellular phone (e.g., client electronic device 42), a notebook computer (e.g., client electronic device 44), a tablet (not shown), a server (not shown), a television (not shown), a smart television (not shown), a media (e.g., video, photo, etc.) capturing device (not shown), and a dedicated network device (not shown). Client electronic devices 38, 40, 42, 44 may each execute an operating system, examples of which may include but are not limited to, Android™, Apple® iOS®, Mac® OS X®; Red Hat® Linux®, or a custom operating system.

One or more of client applications 22, 24, 26, 28 may be configured to effectuate some or all of the functionality of notification process 10 (and vice versa). Accordingly, notification process 10 may be a purely server-side application, a purely client-side application, or a hybrid server-side/client-side application that is cooperatively executed by one or more of client applications 22, 24, 26, 28 and/or notification process 10.

One or more of client applications 22, 24, 26, 28 may be configured to effectuate some or all of the functionality of collaboration application 20 (and vice versa). Accordingly, collaboration application 20 may be a purely server-side application, a purely client-side application, or a hybrid server-side/client-side application that is cooperatively executed by one or more of client applications 22, 24, 26, 28 and/or collaboration application 20. As one or more of client applications 22, 24, 26, 28, notification process 10, and collaboration application 20, taken singly or in any combination, may effectuate some or all of the same functionality, any description of effectuating such functionality via one or more of client applications 22, 24, 26, 28, notification process 10, collaboration application 20, or combination thereof, and any described interaction(s) between one or more of client applications 22, 24, 26, 28, notification process 10, collaboration application 20, or combination thereof to effectuate such functionality, should be taken as an example only and not to limit the scope of the disclosure.

Users 46, 48, 50, 52 may access computer 12 and notification process 10 (e.g., using one or more of client electronic devices 38, 40, 42, 44) directly through network 14 or through secondary network 18. Further, computer 12 may be connected to network 14 through secondary network 18, as illustrated with phantom link line 54. Notification process 10 may include one or more user interfaces, such as browsers and textual or graphical user interfaces, through which users 46, 48, 50, 52 may access notification process 10.

The various client electronic devices may be directly or indirectly coupled to network 14 (or network 18). For example, client electronic device 38 is shown directly coupled to network 14 via a hardwired network connection. Further, client electronic device 44 is shown directly coupled to network 18 via a hardwired network connection. Client electronic device 40 is shown wirelessly coupled to network 14 via wireless communication channel 56 established between client electronic device 40 and wireless access point (i.e., WAP) 58, which is shown directly coupled to network 14. WAP 58 may be, for example, an IEEE 802.11a, 802.11b, 802.11g, Wi-Fi®, and/or Bluetooth™ device that is capable of establishing wireless communication channel 56 between client electronic device 40 and WAP 58. Client electronic device 42 is shown wirelessly coupled to network 14 via wireless communication channel 60 established between client electronic device 42 and cellular network/bridge 62, which is shown directly coupled to network 14.

Some or all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. Bluetooth™ is a telecommunications industry specification that allows, e.g., mobile phones, computers, smart phones, and other electronic devices to be interconnected using a short-range wireless connection. Other forms of interconnection (e.g., Near Field Communication (NFC)) may also be used.

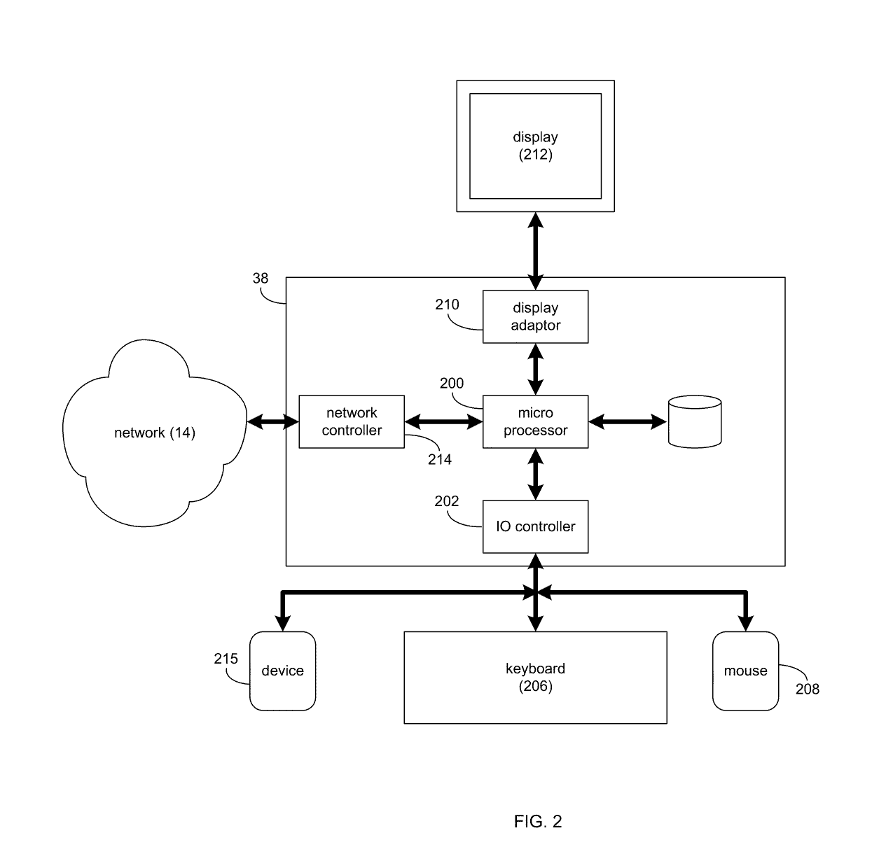

Referring also to FIG. 2, there is shown a diagrammatic view of client electronic device 38. While client electronic device 38 is shown in this figure, this is for illustrative purposes only and is not intended to be a limitation of this disclosure, as other configurations are possible. For example, any computing device capable of executing, in whole or in part, notification process 10 may be substituted for client electronic device 38 within FIG. 2, examples of which may include but are not limited to computer 12 and/or client electronic devices 40, 42, 44.

Client electronic device 38 may include a processor and/or microprocessor (e.g., microprocessor 200) configured to, e.g., process data and execute the above-noted code/instruction sets and subroutines. Microprocessor 200 may be coupled via a storage adaptor (not shown) to the above-noted storage device(s) (e.g., storage device 30). An I/O controller (e.g., I/O controller 202) may be configured to couple microprocessor 200 with various devices, such as keyboard 206, pointing/selecting device (e.g., mouse 208), custom device (e.g., device 215), USB ports (not shown), and printer ports (not shown). A display adaptor (e.g., display adaptor 210) may be configured to couple display 212 (e.g., CRT or LCD monitor(s)) with microprocessor 200, while network controller/adaptor 214 (e.g., an Ethernet adaptor) may be configured to couple microprocessor 200 to the above-noted network 14 (e.g., the Internet or a local area network).

Some email client applications may be equipped with a notification function that a user may enable to let other users know that the user is “Out of the Office”. For example, at time T₀, the user may set up an “Out of Office” function to be enabled between, e.g., a beginning date T₁ and end date T₂. In the example, if an email is sent by, e.g., a second user and received by the email client application before T₁ (e.g., before the “Out of Office” function date is enabled), no automated “Out of Office” notification message is generally sent back to the second user. Continuing with the example, if the email is sent by the second user and received by the email client application between T₁ and T₂ (e.g., after the “Out of Office” function date is enabled), an automated “Out of Office” notification message may be sent back to the second user. Thus, while there may be times when users are actively working with the first user when the first user becomes unavailable, the users may generally not be notified of that unavailability until they send an email to the first after the first user has enabled an “Out of Office” or similar function. Moreover, if multiple communication channels are being used (e.g., including non-email communication channels), the users may not receive any notification message of the unavailability of the first user, as the notification may only be triggered by receipt of an email between T₁ and T₂.

The Notification Process:

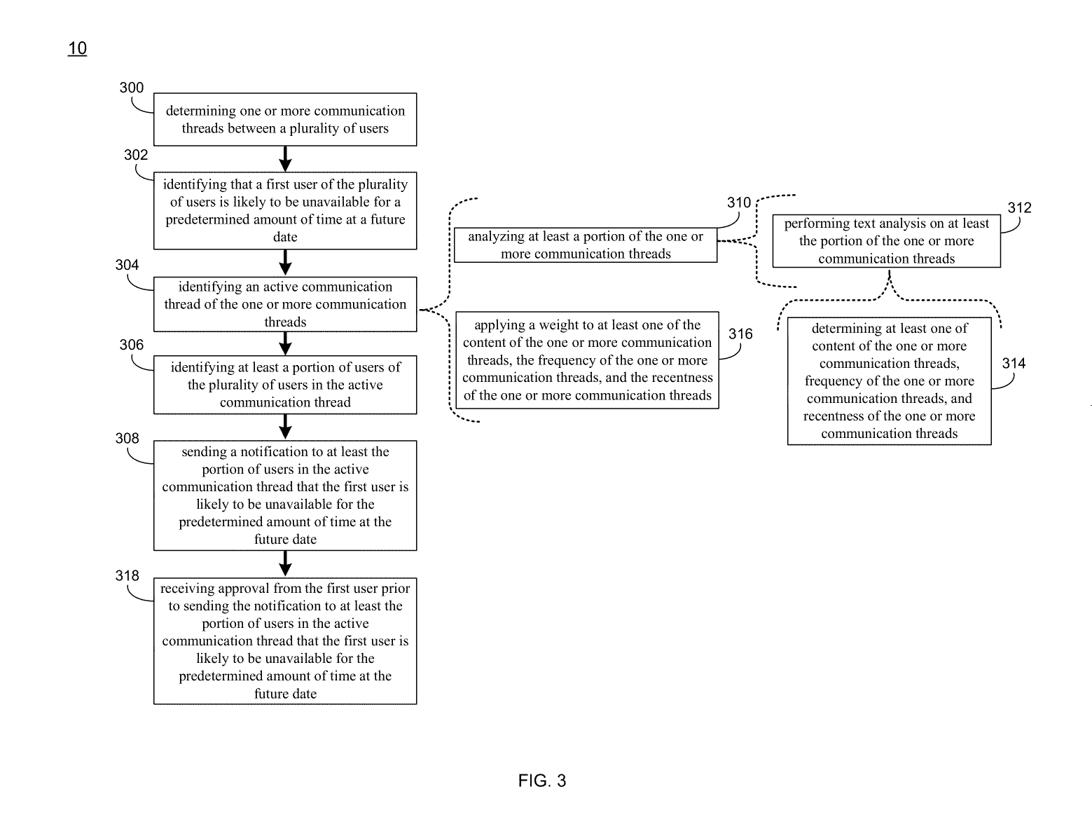

As discussed above and referring also at least to FIGS. 3-5, notification process 10 may determine 300, by a computing device, one or more communication threads between a plurality of users. Notification process 10 may identify 302 a first user of the plurality of users as likely to be unavailable for a predetermined amount of time at a future date. An active communication thread (e.g., active communication thread 19) of the one or more communication threads may be identified 304 by notification process 10. At least a portion of users of the plurality of users in the active communication thread may be identified 306 by notification process 10. Notification process 10 may send 308 a notification (e.g., notification 17) to at least the portion of users in the active communication thread that the first user is likely to be unavailable for the predetermined amount of time at the future date based upon, at least in part, identifying 302 that the first user of the plurality of users is likely to be unavailable for the predetermined amount of time at the future date and identifying 304 the active communication thread, wherein the notification may be sent 308 prior to the future date.

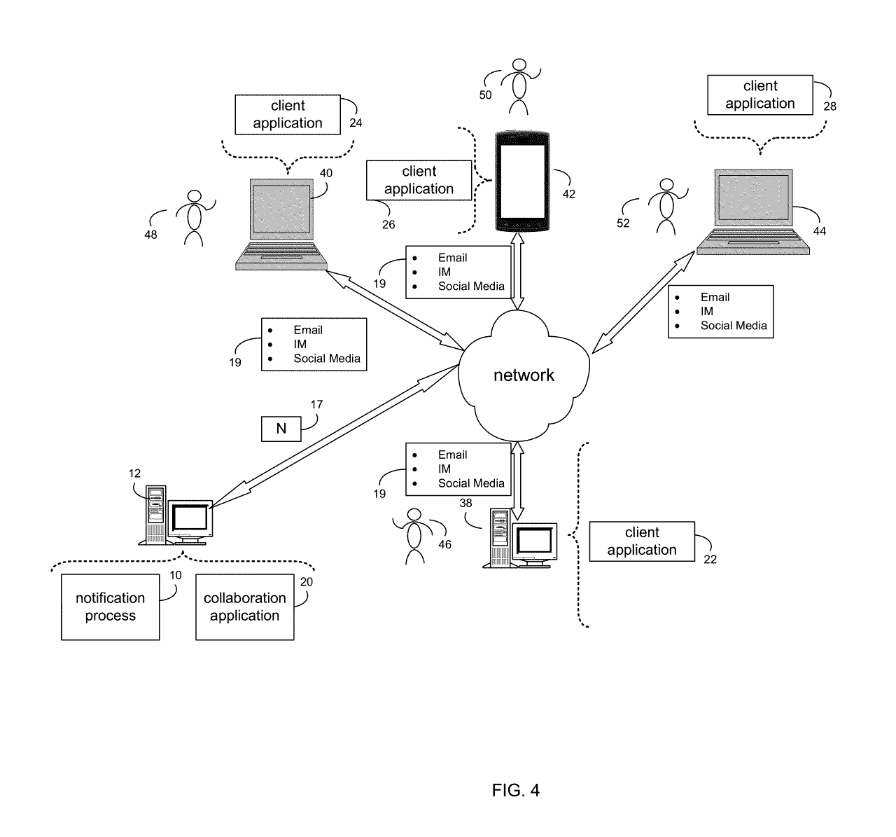

As noted above, notification process 10 may determine 300, by a computing device, one or more communication threads between a plurality of users. For example, and referring at least to FIG. 4, user 46 may be sending/receiving communications to/from one or more users (e.g., users 48, 50, and 52) via their respective client electronic devices. In some implementations, the one or more communication threads may include at least one of an email exchange with the first user, an instant message exchange with the first user, and a social media exchange with the first user. It will be appreciated that other examples of communication threads (and/or combinations thereof) may be used without departing from the scope of the disclosure. For example, SMS/MMS texting may be included as a communication thread. As such, the use of example types of communication threads should be taken as example only and not to limit the scope of the disclosure.

In some implementations, notification process 10 may identify 302 a first user of the plurality of users as likely to be unavailable for a predetermined amount of time at a future date. For instance, assume for example purposes only that the first user (e.g., user 46) has used a calendar function (e.g., from an email client application of client application 22) to enter an event. Further assume that the event includes departing and returning flight information. In the example, notification process 10 may perform text analysis on the calendar of user 46 to identify the event as a travel event between T₁ (e.g., departing date/time) and T₂ (e.g., returning date/time). In the example, notification process 10 may identify 302 user 46 as likely to be unavailable between T₁ and T₂.

As another example, assume for example purposes only that user 46 has used an email function (e.g., from the email client application of client application 22) to exchange emails between, e.g., users 48, 50, and 52. Further assume that one of the emails sent from user 46 includes the phrase “My future plans are to attend the two week conference in Boston on Feb. 1, 2015.” In the example, notification process 10 may perform text analysis on the emails sent from user 46 to identify that user 46 has plans to visit a conference in Boston between T₁ (e.g., beginning of the conference on Feb. 1, 2015) and T₂ (e.g., end of the conference on Feb. 15, 2015). In the example, notification process 10 may identify 302 user 46 as likely to be unavailable between T₁ and T₂.

As another example, assume for example purposes only that user 46 has used an IM function (e.g., from client application 22) to exchange IMs between, e.g., users 48, 50, and 52. Further assume that one of the IMs sent from user 46 includes the phrase “My future plans are to attend the conference in Boston sometime this February.” In the example, as no specific dates are provided in the IMs, notification process 10 may perform text analysis on the IMs sent from user 46 to identify that user 46 has plans to visit a conference in Boston sometime in February. In the example, T₁ may include the beginning of February and T₂ may include the last day in February (or a pre-determined length of time after the last day in February). In the example, notification process 10 may identify 302 user 46 as likely to be unavailable between T₁ and T₂.

As another example, assume for example purposes only that user 46 has used a social media function (e.g., from client application 22) to interact with, e.g., users 48, 50, and 52. The interaction may include, e.g., posting messages on profile pages, sending private messages, other types of social media interactions, etc. Further assume that one of the social media interactions includes a message sent from user 46 that includes the phrase “My future plans are to attend the conference in Boston sometime this February.” In the example, as no specific dates are provided in the social media messages, notification process 10 may perform text analysis on the social media messages sent from user 46 to identify that user 46 has plans to visit a conference in Boston sometime in February. In the example, T₁ may include the beginning of February and T₂ may include the last day in February (or a pre-determined length of time after the last day in February). In the example, notification process 10 may identify 302 user 46 as likely to be unavailable between T₁ and T₂. It will be appreciated that the more information available to notification process 10 for text analysis (e.g., dates, times, locations, etc.), the more accurate the determination/identification 302 of the likelihood that user 46 will be unavailable, as well as the specifics of T₁ and T₂.

It will be appreciated that other techniques may be used to identify 302 that user 46 may be unlikely to be available. For example, user 46 may set up a typical “Out of Office” function for a future date. As another example, notification process 10 may analyze the email/calendar of user 46 to determine whether user 46 has scheduled and/or accepted an event invite. As such, the above examples of how to identify 302 that user 46 may be unlikely to be available should be taken as example only and not to limit the scope of the disclosure.

In some implementations, an active communication thread of the one or more communication threads may be identified 304 by notification process 10. An active communication thread may include, e.g., a communication thread between user 46 and any other user that may identify 304 whether or not that user should be made aware of the potential for user 46 to be unavailable between T₁ and T₂(e.g., those users currently and/or actively engaged with user 46). For example, identifying 304 the active communication thread may include notification process 10 analyzing 310 at least a portion of the one or more communication threads. As noted above, the one or more communication threads may include at least one of an email exchange with the first user, an instant message exchange with the first user, and a social media exchange with the first user. Assume for example purposes only that a first communication thread is an email thread between user 46 and users 48 and 50. In the example, further assume that a second communication thread is an email thread between user 46 and user 52. In the example, the first and second communication threads may be analyzed 310 by notification process 10. It will be appreciated that any number and types of communication threads may be analyzed 310 without departing from the scope of the disclosure.

In some implementations, analyzing 310 at least the portion of the one or more communication threads may include notification process 10 performing 312 text analysis on at least the portion of the one or more communication threads. For instance, and continuing with the above example, notification process 10 may perform 312 text analysis on the first and second communication threads (e.g., first and second email threads). In some implementations, performing 312 text analysis may include notification process 10 determining 314 at least one of content of the one or more communication threads, frequency of the one or more communication threads, and recentness of the one or more communication threads.

For instance, assume for example purposes only that an email from the above-noted first email thread is sent from user 48 to users 46 and 50 via their respective client electronic devices. Further in the example, assume that the email sent from user 48 includes the word/phrase, e.g., “please let me know by February” or “expect your response by February 5^{th}”. In the example, the first email thread may be considered (e.g., identified 304 as) an active communication thread, since, e.g., notification process 10 may determine 314 that the content of the email sent from user 48 may identify 304 that at least user 48 should be made aware of the potential for user 46 to be unavailable during all of February and/or February 5^{th}, as this is a time noted from the content of the email thread when information has been request by user 48 from user 46.

It will be appreciated that other words and/or phrases may be identifiable from the content of the communication threads without departing from the scope of the disclosure. As such, the specific example words/phrases used should be taken as example only and not to limit the scope of the disclosure. In some implementations, notification process 10 may enable, e.g., user 46, to manually enter/change the words/phrases via a user interface (not shown) that may be indicative of an active communication thread.

As another example, assume for example purposes only that an email from the above-noted first email thread is sent from user 48 to users 46 and 50 via their respective client electronic devices. Further in the example, assume that the email exchanges between user 46 and 48 are frequent (e.g., at least one email exchange per day). In the example, the first email thread may be considered (e.g., identified 304 as) an active communication thread, since, e.g., notification process 10 may determine 314 that the frequency of emails sent between user 48 and user 46 may identify 304 that at least user 48 should be made aware of the likelihood for user 46 to be unavailable in the future, as the frequency of emails may indicate that continued email communication at the same or similar frequency may be expected by user 48.

It will be appreciated that the threshold frequency of exchanges to be considered an active communication thread may vary without departing from the scope of the disclosure. For example, the frequency threshold may include the number of email exchanges between users per minute, hour, day, week, month, year, etc. As such, the frequency threshold described should be taken as example only and not to limit the scope of the disclosure. In some implementations, notification process 10 may enable, e.g., user 46, to manually enter/change the frequency threshold via a user interface (not shown) that may be indicative of an active communication thread.

As another example, assume for example purposes only that an email from the above-noted first email thread is sent from user 48 to users 46 and 50 via their respective client electronic devices. Further in the example, assume that the email exchanges between user 46 and 48 were frequent (e.g., at least one email exchange per day), but that the last email exchange between user 46 and user 48 was three months ago. In the example, the first email thread may not be considered (e.g., identified 304 as) an active communication thread, since, e.g., notification process 10 may determine 314 that the recentness of the emails between user 48 and user 46 may identify 304 that at least user 48 may not need to be made aware of the likelihood for user 46 to be unavailable in the future, as the recentness of the last email exchange may indicate that continued email communication may not be expected by user 48.

It will be appreciated that the threshold recentness of exchanges to be considered an active communication thread may vary without departing from the scope of the disclosure. For example, the recentness threshold may include the most recent number of email exchanges between users by the minute, hour, day, week, month, year, etc. As such, the recentness threshold described should be taken as example only and not to limit the scope of the disclosure. In some implementations, notification process 10 may enable, e.g., user 46, to manually enter/change the recentness threshold via a user interface (not shown) that may be indicative of an active communication thread.

In some implementations, identifying 304 the active communication thread may include notification process 10 applying 316 a weight to at least one of the content of the one or more communication threads, the frequency of the one or more communication threads, and the recentness of the one or more communication threads. For instance, assume for example purposes only that an email communication thread satisfies the content requirements (e.g., includes the phrase “please let me know by February”), but does not satisfy the recentness requirement. In the example, if notification process 10 applies 316 a heavier weight to the content requirement than is applied 316 to the recentness requirements, notification process 10 may still identify 304 the communication thread as an active communication thread, denoting that at least user 48 should be made aware of the likelihood for user 46 to be unavailable in the future. Conversely, if notification process 10 applies 316 a lighter weight to the content requirement than is applied 316 to the recentness requirements, notification process 10 may not identify 304 the communication thread as an active communication thread, denoting that at least user 48 may not need to be made aware of the likelihood for user 46 to be unavailable in the future.

In some implementations, the weight applied 316 may vary within the same requirement. For instance, the weight provided to the recentness of the communication thread may decrease as the recentness of the email communications decreases. Conversely, the weight provided to the recentness of the communication thread may increase as the recentness of the email communications increases. As another example, the weight provided to the frequency of the communications may decrease as the frequency of the communications decreases. Conversely, the weight provided to the frequency of the communications may increase as the frequency of the communications increases.

It will be appreciated that the weights and combination of weights that may be used by notification process 10 to consider a communication thread as an active communication thread may vary without departing from the scope of the disclosure. As such, the weights and formulas for determining whether a communication thread is active should be taken as example only and not to limit the scope of the disclosure. In some implementations, notification process 10 may enable, e.g., user 46, to manually enter/change the weights via a user interface (not shown) for the formula that may be indicative of an active communication thread.

At least a portion of users of the plurality of users in the active communication thread may be identified 306 by notification process 10. For example, users 48 and 50 (and/or user 46) may be identified 306 by notification process 10 based upon users 48 and 50 being included on the active communication thread. In some implementations, the above-noted analysis may be performed individually per user before being identified 306 as a user that should be made aware of the likelihood for user 46 (and/or vice versa) to be unavailable in the future. For instance, assume for example purposes only that while the active communication thread includes both users 48 and 50, only the correspondence from user 48 in the active communication thread has made the communication thread active. In the example, user 50 may not be identified 306 as a user that should be made aware of the likelihood for user 46 to be unavailable in the future. In some implementations, even if user 48 is identified 306 as a user that should be made aware of the likelihood for user 46, user 46 may still require similar analysis 310 as noted above before user 46 is identified 306 as a user that should be made aware of the likelihood for user 48.

In some implementations, assume for example purposes only that, after performing the above-noted analysis 310 on the second communication thread between user 46 and user 52, that the second communication thread is not considered (e.g., identified 304 as) an active communication thread. In the example, user 52 may not be identified 306 as a user that should be made aware of the likelihood for user 46 to be unavailable in the future.

In some implementations, notification process 10 may send 308 a notification to at least the portion of users in the active communication thread that the first user is likely to be unavailable for the predetermined amount of time at the future date based upon, at least in part, identifying 302 that the first user of the plurality of users is likely to be unavailable for the predetermined amount of time at the future date and identifying 304 the active communication thread, wherein the notification may be sent 308 prior to the future date. For example, continue with the above example where the first email thread between users 46, 48, and 50 may be considered (e.g., identified 304 as) an active communication thread, and one of the emails sent from user 46 includes the phrase “My future plans are to attend the two week conference in Boston on Feb. 1, 2015.” In the example, further assume that users 48 and 50 are identified 306 by notification process 10 based upon users 48 and 50 being included on the active communication thread. In the example, notification process 10 may send 308 a notification to users 48 and 50 that user 46 is likely to be unavailable from T₁ (e.g., beginning of the conference on Feb. 1, 2015) and T₂ (e.g., end of the conference on Feb. 15, 2015).

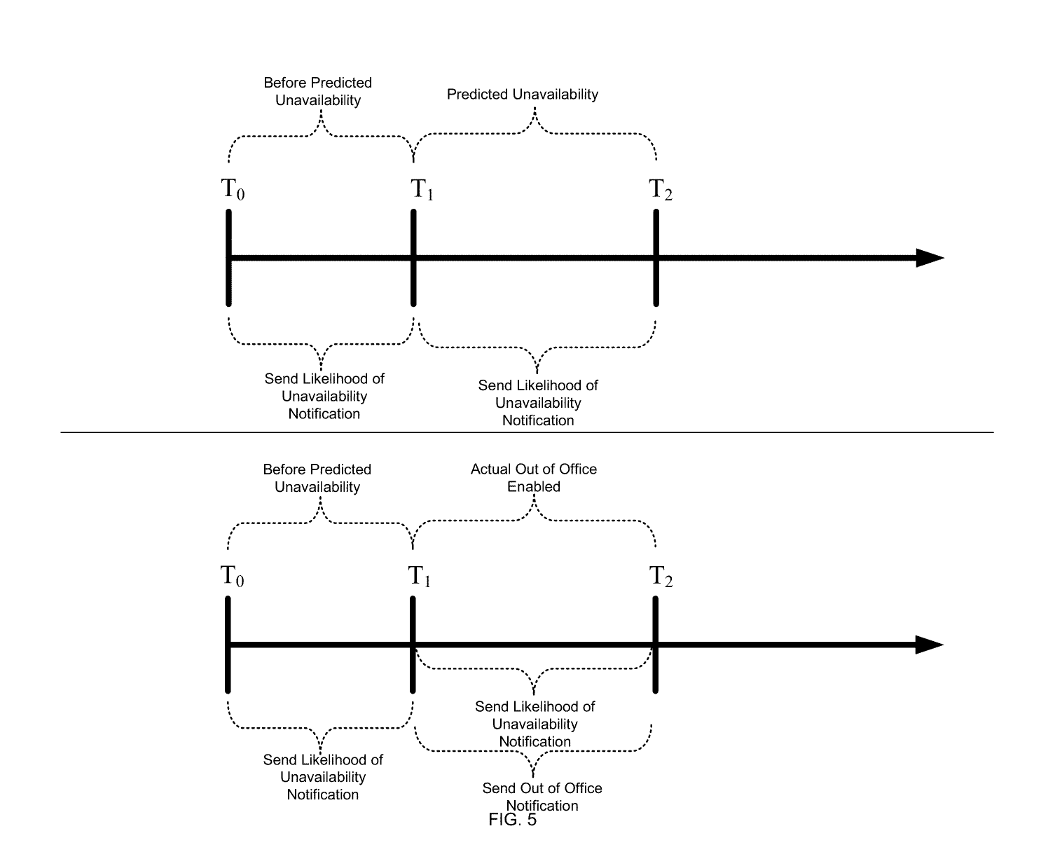

In some implementations, subsequent communications between user 46 and users 48 and 50 may not be required for notification process 10 to send 308 the above-noted notification, and/or subsequent communications between user 46 and users 48 and 50 may not be required between T₁ and T₂ for notification process 10 to send 308 the above-noted notification. For example, and referring at least to the upper portion of FIG. 5, assume that T₀ is the point when notification process 10 identifies 302 user 46 as likely to be unavailable between T₁ and T₂. In the example, regardless of whether users 48 and 50 send a communication to user 46 between T₀ and T₁, notification process 10 may send 308 the above-noted notification to users 48 and 50, at least based upon users 48 and 50 being included in an active communication thread with user 46. Conversely, regardless of whether user 52 sends a communication to user 46 between T₀ and T₁, notification process 10 may not send 308 the above-noted notification to user 52, at least based upon user 52 being included in a communication thread with user 46 that is not considered an active communication thread. That is, in some implementations, rather than relying upon when/if a subsequent communication is received, the receipt of the above-noted notification may be based upon identifying 302 that user 46 is likely to be unavailable at a future date and identifying 304 users 48 and 50 as being included in an active communication thread. This may be contrasted with known “Out of Office” application functions, where, e.g., unavailability notifications may not be predictive and typically only sent non-discriminately to any recipient as an automated reply if the recipient sends an email to someone during the times when an “Out of Office” function is enabled (e.g., during the dates manually input by a user). In some implementations, the (predictive) notification may be sent anytime between T₀ and T₂. Moreover, and referring to the lower portion of FIG. 5, in some implementations, notification process 10 may be combined with typical “Out of Office” functionality, such that notification process 10 may send 308 the above-noted (predictive) notification to users 48 and 50 in advance of users from non-active communication threads anytime between T₀ and T₁ (e.g., where T₀ may also be when user 46 sets up but does not enable “Out of Office” function), and may send actual “Out of Office” notifications to any user that sends an email to user 46 when an “Out of Office” function is enabled (e.g., between T₁ and T₂). In some implementations, the predictive notification may be sent anytime between T₀ and T₂.

In some implementations, approval from the first user may be received 318 by notification process 10 prior to sending 308 the notification to at least the portion of users in the active communication thread that the first user is likely to be unavailable for the predetermined amount of time at the future date. For example, notification process 10 may enable, e.g., user 46, to manually enter/change via a user interface (not shown) a list of who receives the above-noted notification, the content of the notification, whether any notification is sent, etc. For instance, notification process 10 may provide a display that may enable user 46 to predetermine who receives the above-noted notification, and/or the content of the notification. In some implementations, before a notification is sent, notification process 10 may provide a verification message that may enable user 46 to confirm and/or cancel sending such a notification to one or more users (e.g., user 48 and 50).

The terminology used herein is for the purpose of describing particular implementations only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps (not necessarily in a particular order), operations, elements, and/or components, but do not preclude the presence or addition of one or more other features, integers, steps (not necessarily in a particular order), operations, elements, components, and/or groups thereof.

The corresponding structures, materials, acts, and equivalents of all means or step plus function elements that may be in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications, variations, and any combinations thereof will be apparent to those of ordinary skill in the art without departing from the scope and spirit of the disclosure. The implementation(s) were chosen and described in order to best explain the principles of the disclosure and the practical application, and to enable others of ordinary skill in the art to understand the disclosure for various implementation(s) with various modifications and/or any combinations of implementation(s) as are suited to the particular use contemplated.

Having thus described the disclosure of the present application in detail and by reference to implementation(s) thereof, it will be apparent that modifications, variations, and any combinations of implementation(s) (including any modifications, variations, and combinations thereof) are possible without departing from the scope of the disclosure defined in the appended claims.

What is claimed is:

1. A computer-implemented method comprising:
determining, by a computing device, one or more communication threads between a plurality of users;
identifying that a first user of the plurality of users is likely to be unavailable for a predetermined amount of time at a future date;
identifying an active communication thread of the one or more communication threads;
identifying at least a portion of users of the plurality of users in the active communication thread; and
sending a notification to at least the portion of users in the active communication thread that the first user is likely to be unavailable for the predetermined amount of time at the future date based upon, at least in part, identifying that the first user of the plurality of users is likely to be unavailable for the predetermined amount of time at the future date and identifying the active communication thread, wherein the notification is sent prior to the future date.

2. The computer-implemented method of claim 1 wherein identifying the active communication thread includes analyzing at least a portion of the one or more communication threads.

3. The computer-implemented method of claim 1 wherein the one or more communication threads include at least one of an email exchange with the first user, an instant message exchange with the first user, and a social media exchange with the first user.

4. The computer-implemented method of claim 2 wherein analyzing at least the portion of the one or more communication threads includes performing text analysis on at least the portion of the one or more communication threads.

5. The computer-implemented method of claim 4 wherein performing text analysis includes determining at least one of content of the one or more communication threads, frequency of the one or more communication threads, and recentness of the one or more communication threads.

6. The computer-implemented method of claim 5 wherein identifying the active communication thread includes applying a weight to at least one of the content of the one or more communication threads, the frequency of the one or more communication threads, and the recentness of the one or more communication threads.

7. The computer-implemented method of claim 1 further comprising receiving approval from the first user prior to sending the notification to at least the portion of users in the active communication thread that the first user is likely to be unavailable for the predetermined amount of time at the future date.

8. A computer program product residing on a computer readable storage medium having a plurality of instructions stored thereon which, when executed by a processor, cause the processor to perform operations comprising:
determining one or more communication threads between a plurality of users;
identifying that a first user of the plurality of users is likely to be unavailable for a predetermined amount of time at a future date;
identifying an active communication thread of the one or more communication threads;
identifying at least a portion of users of the plurality of users in the active communication thread; and
sending a notification to at least the portion of users in the active communication thread that the first user is likely to be unavailable for the predetermined amount of time at the future date based upon, at least in part, identifying that the first user of the plurality of users is likely to be unavailable for the predetermined amount of time at the future date and identifying the active communication thread, wherein the notification is sent prior to the future date.

9. The computer program product of claim 8 wherein identifying the active communication thread includes analyzing at least a portion of the one or more communication threads.

10. The computer program product of claim 8 wherein the one or more communication threads include at least one of an email exchange with the first user, an instant message exchange with the first user, and a social media exchange with the first user.

11. The computer program product of claim 9 wherein analyzing at least the portion of the one or more communication threads includes performing text analysis on at least the portion of the one or more communication threads.

12. The computer program product of claim 11 wherein performing text analysis includes determining at least one of content of the one or more communication threads, frequency of the one or more communication threads, and recentness of the one or more communication threads.

13. The computer program product of claim 12 wherein identifying the active communication thread includes applying a weight to at least one of the content of the one or more communication threads, the frequency of the one or more communication threads, and the recentness of the one or more communication threads.

14. The computer program product of claim 8 further comprising receiving approval from the first user prior to sending the notification to at least the portion of users in the active communication thread that the first user is likely to be unavailable for the predetermined amount of time at the future date.

15. A computing system including a processor and a memory configured to perform operations comprising:
determining one or more communication threads between a plurality of users;
identifying that a first user of the plurality of users is likely to be unavailable for a predetermined amount of time at a future date;
identifying an active communication thread of the one or more communication threads;
identifying at least a portion of users of the plurality of users in the active communication thread; and
sending a notification to at least the portion of users in the active communication thread that the first user is likely to be unavailable for the predetermined amount of time at the future date based upon, at least in part, identifying that the first user of the plurality of users is likely to be unavailable for the predetermined amount of time at the future date and identifying the active communication thread, wherein the notification is sent prior to the future date.

16. The computing system of claim 15 wherein identifying the active communication thread includes analyzing at least a portion of the one or more communication threads.

17. The computing system of claim 15 wherein the one or more communication threads include at least one of an email exchange with the first user, an instant message exchange with the first user, and a social media exchange with the first user.

18. The computing system of claim 16 wherein analyzing at least the portion of the one or more communication threads includes performing text analysis on at least the portion of the one or more communication threads.

19. The computing system of claim 18 wherein performing text analysis includes determining at least one of content of the one or more communication threads, frequency of the one or more communication threads, and recentness of the one or more communication threads.

20. The computing system of claim 19 wherein identifying the active communication thread includes applying a weight to at least one of the content of the one or more communication threads, the frequency of the one or more communication threads, and the recentness of the one or more communication threads.
